(19) United States
(12) Patent Application Publication
(10) Pub. No.: US 2024/0308099 A1
(43) Pub. Date: Sep. 19, 2024

(54) FOOD-PROCESSING SYSTEM

(71) Applicant: PROVISUR TECHNOLOGIES, INC., Chicago, IL (US)

(72) Inventors: Jürgen BIALY, Oeschebüttel (DE); Klaus GUGGEMOS, Rettenberg (DE); Paul GOROLL, Waltenhofen (DE); Matthias HINDORFF, Waltenhofen (DE); Alexander MAY, Waltenhofen (DE); Klaus Dieter SCHROFF, Konstanz (DE); Florian MOHR, Sulzberg (DE)

(21) Appl. No.: 18/548,831

(22) PCT Filed: Feb. 17, 2022
(86) PCT No.: PCT/EP2022/053942

§ 371 Date: Sep. 1, 2023

(30) Foreign Application Priority Data
Mar. 3, 2021 (DE) 10 2021 105 098.7

(51) Int. Cl. B26D 7/32; B26D 5/00; B26D 7/18; B26D 7/30

(52) U.S. Cl. CPC B26D 7/32; B26D 5/007; B26D 7/1836; B26D 7/1854; B26D 7/1863; B26D 7/30; B26D 2210/02

(57) ABSTRACT

The invention relates to a food-processing system for processing food products (e.g. pieces of meat, pieces of cheese), comprising a cutting device (1) for cutting the food products into slices and a conveyor (4) for conveying the food product portions (6) away from the cutting device (1) along a main conveyor path, wherein the conveyor (4) fulfills several functions in the food-processing system, such as buffering, aligning, orienting and product formatting of the food product portions. The invention provides that the conveyor (4) fulfills the multiple functions by means of a discontinuous conveyor (4), the discontinuous conveyor (4) comprising at least one conveyed-products carrier (3) movable along the main conveying path, the main conveying path being freely programmable within a conveying area.

The invention relates to a food-processing system for processing food products, in particular for slicing pieces of meat, pieces of cheese, sausage sticks or salami sticks.

Such food-processing systems are known from the prior art, which firstly comprise a cutting device, which is also referred to as a “slicer” in accordance with the usual technical terminology, and which slices the food products (e.g. pieces of meat, pieces of cheese, sausage sticks or salami sticks), one or more of the slices then forming a food product portion.

Furthermore, the known food-processing systems have complicated conveyor systems which take over the food product portions from the cutting device and transport them to a packaging machine (e.g. thermoforming device).

Here, the conveyor system between the cutting device and the packaging machine fulfills several functions, which are briefly described below. For example, the conveyor system can buffer the food product portions delivered by the cutting device in a buffer zone by means of a buffer conveyor, so that a sufficient quantity of food product portions is always available downstream of the buffer zone. In addition, the conveyor system can align the food product portions in a lateral direction transverse to the main conveying path by means of so-called shuttle conveyors, the shuttle conveyors being displaceable transverse to the main conveying path. Furthermore, there is the possibility that the food product portions are reoriented, for example by rotating the food product portions. Finally, there is also the possibility of product formatting, for example by converting a certain number of incoming conveyor tracks into a certain number of outgoing conveyor tracks. In this way, for example, a three-track cutting device can feed a two-track packaging machine.

In the known food-processing systems, the functions briefly described above are realized by a complicated arrangement of conveyor belts, so that the known food-processing system is relatively complicated. Thus, in the prior art, to perform the various functions (buffering, aligning, reorienting, product formatting), belt conveyors are used which belong to the group of continuous conveyors and are relatively complicated.

The invention is therefore based on the task of improving the above-described known food-processing systems accordingly.

This task is solved by a food-processing system according to the main claim.

First of all, in accordance with the prior art, the food-processing system according to the invention comprises a cutting device (“slicer”) for cutting food products into slices which then form food product portions. The food products can be, for example, pieces of meat, pieces of cheese, sticks of sausage or sticks of salami, as is also the case in the prior art. Furthermore, it should be mentioned that the food product portions formed from the cut slices each comprise one or more of the cut slices. Thus, a food product portion may be a stack of slices comprising a plurality of slices stacked on top of each other. Further, within the scope of the invention, it is possible for each of the individual food product portions to be shingles comprising a plurality of slices stacked on top of each other and laterally offset from each other. However, the invention is not limited to the portion shapes described above, but can also be realized with other portion shapes (e.g. “shaved meat”, laid round, etc.).

In addition, the food-processing system according to the invention also has a conveyor system which transports the food product portions away from the cutting device along a main conveyor path. The conveyor system also fulfills several of the functions described briefly above (buffering, aligning, orienting, product formatting). In contrast to the prior art described above, however, the conveyor system fulfills these technical functions by means of a discontinuous conveyor which has at least one conveyed-products carrier (“mover”) which can be moved along the main conveying path, the main conveying path being freely programmable within a conveying surface. The concept of a discontinuous conveyor used in the context of the invention distinguishes the invention, in accordance with the usual technical terminology, from continuous conveyors, such as conveyor belts, which are used in the known prior art food-processing system described at the outset. The food-processing system according to the invention thus differs from the prior art first of all by the type of conveyor (discontinuous conveyor instead of a continuous conveyor).

The discontiuous conveyor can be, for example, a planar motor drive system such as that marketed by the German company Beckhoff Automation GmbH under the product name “XPlanar”. The discontinuous conveyor thus preferably has a magnetic levitation system so that the individual conveyed-products carriers float contactlessly above the conveying surface, whereby the conveying path of the individual conveyed-products carriers can be freely programmed individually for the individual conveyed-products carriers. The movement of the individual conveyed-products carriers is thus preferably not bound to a fixed conveying path. Furthermore, it should be mentioned that the discontinuous conveyor preferably comprises numerous modules, each of which is preferably rectangular and can therefore optionally be assembled to form a continuous conveying surface. This modular design of the continuous conveyor allows a great flexibility with regard to the shape of the conveying surface.

With regard to the design and mode of operation of the individual conveyed-products carriers, reference is made to the German patent application DE 10 2020 105 678.8, the contents of which are fully attributable to the present description. At this point, it is only necessary to mention that the individual conveyed-products carriers preferably have elongated parallel recesses in their loading surface, into which finger conveyors can dive in order to reach under and convey away the food product portion lying on the conveyed-products carrier, as will be described in detail. For this purpose, the conveyed-products carrier can have a plurality of pins on its upper side, which project parallel to the top and form with their free end faces the loading surface for receiving the food product portions. The pins are preferably arranged in a matrix in rows and columns, with the spaces between the rows and also the spaces between the columns forming the elongated recesses into which the finger conveyors can dive to discharge the food product portions.

In a preferred embodiment of the invention, the food-processing system additionally comprises a checking station for checking the food product portions conveyed by the conveyor system for compliance with predetermined product specifications and for detecting faulty portions that do not meet the predetermined product specifications. In addition, an ejection discharge station is preferably provided to discharge the faulty portions from the main conveying path so that the faulty portions do not reach the packaging machine and are not readily delivered to customers. For example, the checking station can weigh the food product portions and compare the weight of the food product portions to a predetermined target weight to determine the faulty portions. In addition, the checking station may also optically inspect the food product portions with a sensor (e.g., camera) to detect voids or faulty portions. The defects can be, for example, weight deviations, volume deviations, shape deviations or quality deviations, to name just a few examples.

Furthermore, the food-processing system may also include a correction zone where the faulty portions can be corrected. For example, the faulty portions are first discharged from the ejection station to the correction zone, where correction of the faulty portions can take place. If, for example, a food product portion comprises too few slices, the food product portion can be completed in the correction zone with a corresponding number of missing slices. This correction of faulty portions can optionally be done manually or automatically. After correction of a faulty portion, the corrected faulty portion can then be reintroduced into the main conveying path by the ejection station. The ejection station can be formed by the discontinuous conveyor, since the conveying path can be freely programmed within the conveying area. The discontinuous conveyor can therefore optionally transport the faulty portions along the main conveying path in the direction of the packaging machine or, in the case of a faulty portion, convey them to the correction station.

In addition, the conveyor system according to the invention can also have a discharge station for disposing of unusable product residues. For example, a cutting process usually produces initial pieces and end pieces that are not usable. These non-recyclable product pieces can then also be initially deposited on a conveyed-products carrier, which then transports the non-recyclable product pieces to the discharge station, where disposal can take place.

At the discharge station, the non-usable product pieces (e.g. initial pieces, end pieces) are then removed from the conveyed-products carrier. For example, a gripper can be provided for this purpose, which grips the initial piece or end piece on the conveyed-products carrier and then transports it away under robot guidance. Alternatively, there is the possibility of a suction device that sucks in the unusable initial piece or end piece and then transports it away. Another possibility for removing the non-usable product pieces from the conveyed-products carrier is a pusher which pushes the non-usable product pieces (e.g. initial piece, end piece) off the conveyed-products carrier. Alternatively, it is possible that the complete conveyed-products carrier is tilted by a tilting device, so that the non-usable product pieces slide down from the conveyed-products carrier. Furthermore, a blowing device can be provided, which blows the non-usable product pieces off the conveyed-products carrier. Finally, it is also possible that the non-usable product pieces are removed from the conveyed-products carrier by jerky acceleration or deceleration of the conveyed-products carrier.

It has already been mentioned above that a technical function of the conveyor system is to orient the food product portions according to a desired orientation. For this purpose, the food product portions can be rotated together with the conveyed-products carrier about an axis of rotation, which is preferably perpendicular to the conveying surface. To assist in this orientation, the conveyor system may have a camera to detect the orientation of the food product portions on the conveyed-products carriers. The individual conveyed-products carriers are then preferably rotated before the product is deposited by the cutting device in order to later achieve a desired orientation of the food product portions on the individual conveyed-products carriers on the output side. If, for example, the cutting device deposits the individual food product portions with a misorientation of 10° to the main conveying path, the individual conveyed-products carriers are preferably rotated by this angle when the food product portions are taken over by the cutting device. After a food product portion has been taken over from the cutting device, the conveyed-products carrier can then be oriented parallel to the main conveying path again, thus producing the desired orientation. This reorientation of the conveyed-products carriers and the food product portions thereon can be performed by the discontinuous conveyor, so that no additional components are required for this. For example, the conveyed-products carriers with the food product portions thereon can also be rotated by 90° or 180° in order to achieve the desired orientation of the food product portions, whereby this rotation can also take place without a camera control.

Furthermore, within the scope of the invention, there is the possibility that the discontinuous conveyor is also involved in the creation of overlapping food product portions. For this purpose, a belt conveyor is arranged above the conveying surface of the discontinuous conveyor, which is fed with food product portions by the conveyed-products carriers. Another conveyed-products carrier is then moved under the belt conveyor with a food product portion. Subsequently, the food product portions on the belt conveyor, on the one hand, and on the conveyed-products carrier below the belt conveyor, on the other hand, are moved in the initial direction, the belt conveyor then depositing its food product portion on the food product portion on the conveyed-products carrier with a predetermined overlap.

Furthermore, within the scope of the invention, it is also possible that the conveyor system comprises a transfer device for transferring slices of the food product portions between different conveyed-products carriers. For example, this transfer device may comprise a belt conveyor having on the input side a plurality of finger conveyors or knife conveyors which can enter the elongated recesses of a conveyed-products carrier in order to grip underneath and convey away the food product portions located there. This enables the completion of incomplete food product portions. If, for example, during a cutting process the number of slices cut off is not sufficient to produce a complete food product portion with the desired number of slices, the missing slices can be completed by another conveyed-products carrier.

Furthermore, it should be mentioned that the food-processing system according to the invention can have a certain number of cutting devices and a certain number of packaging machines, which do not have to be the same. For example, one cutting device can feed several packaging machines. In this case, the discontinuous conveyor makes it possible to divide up or combine the product streams accordingly.

It should further be noted that the invention does not only claim protection for the food-processing system according to the invention as described above. Rather, the invention also claims protection for an operating method for such a food-processing system. The individual process steps of the operating method according to the invention result here from the above description, so that a separate description of the individual process steps of the operating method according to the invention can be dispensed with.

Other advantageous further embodiments of the invention are indicated in the dependent claims or are explained in more detail below together with the description of the preferred embodiments of the invention with reference to the figures.

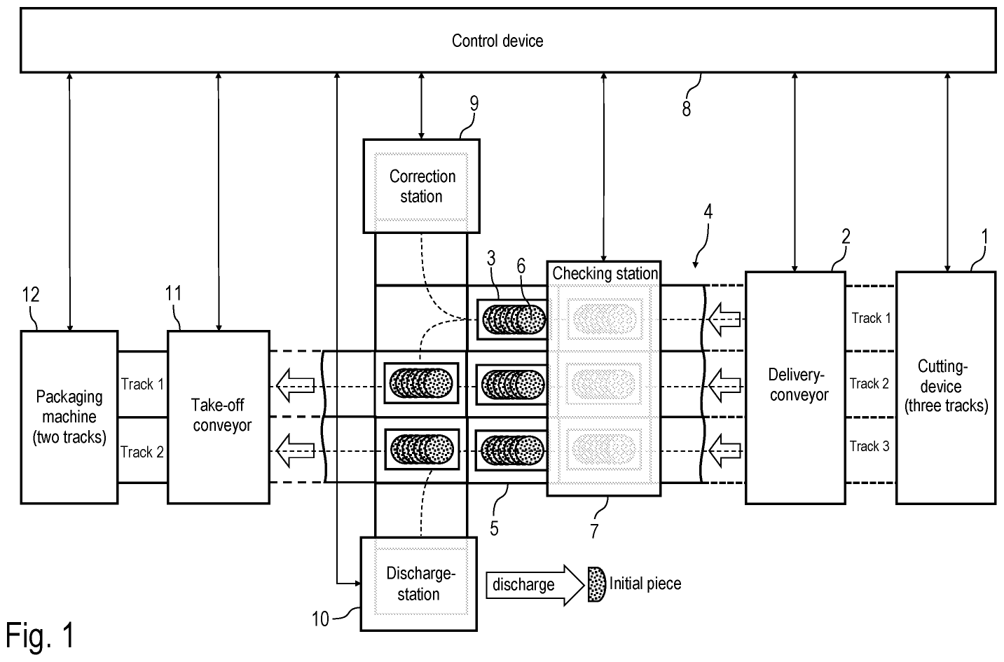

FIG. 1 shows a schematic representation of a food-processing system according to the invention.

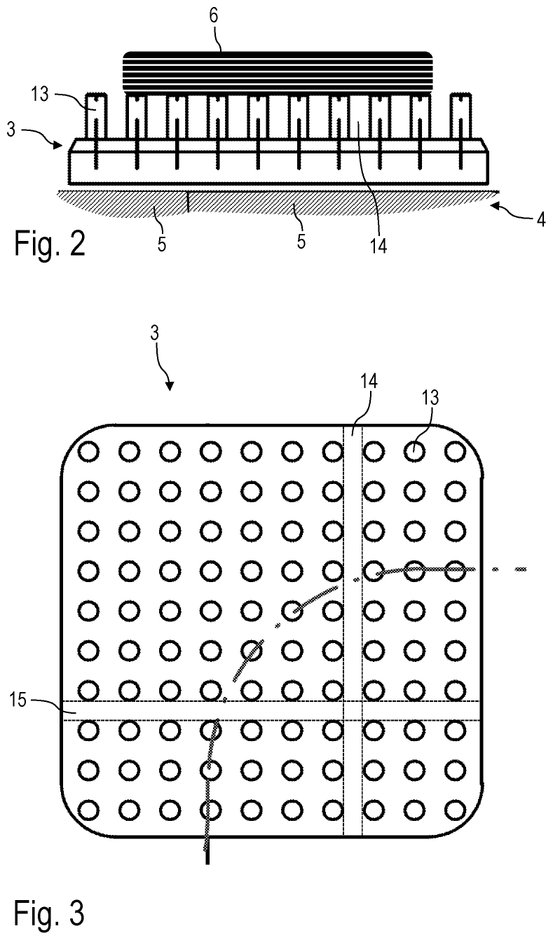

FIG. 2 shows a side view of a conveyed-products carrier of the food-processing system of FIG. 1.

FIG. 3 shows a top view of the conveyed-products carrier according to FIG. 2.

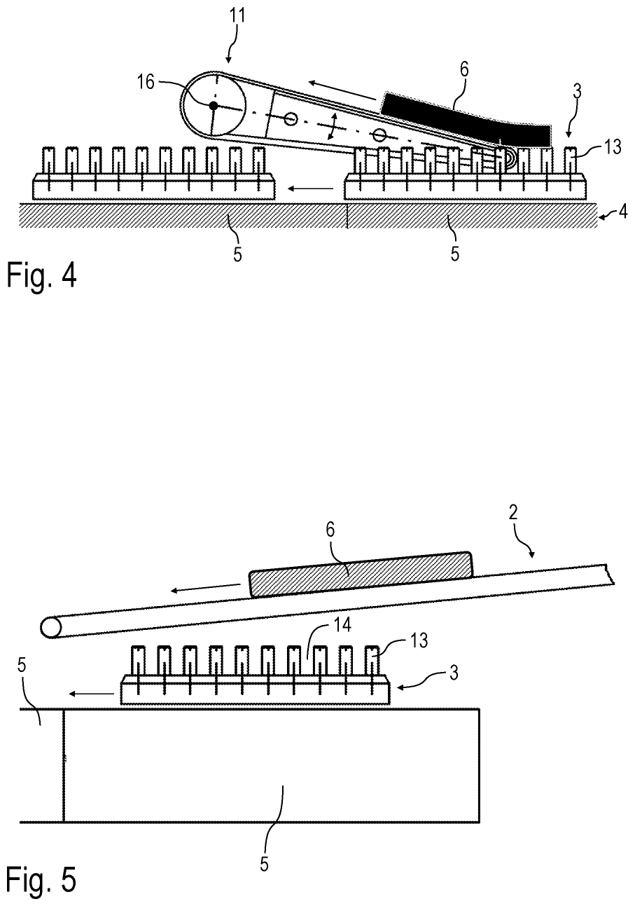

FIG. 4 shows a side view of a take-off conveyor for taking off the food product portions from the individual carriers.

FIG. 5 shows a side view of a discharge conveyor for discharging the food product portions onto the individual conveyed-products carriers.

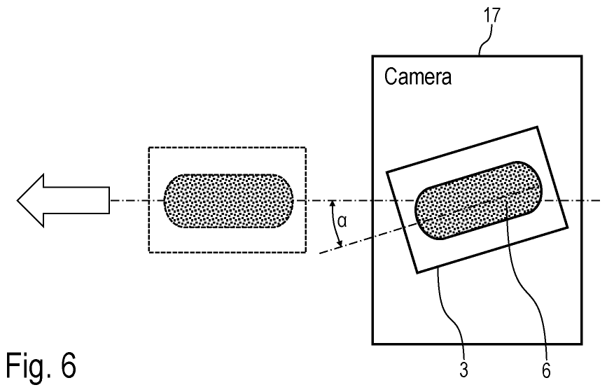

FIG. 6 shows a schematic view of the reorientation of the food product portions on the conveyed-products carriers.

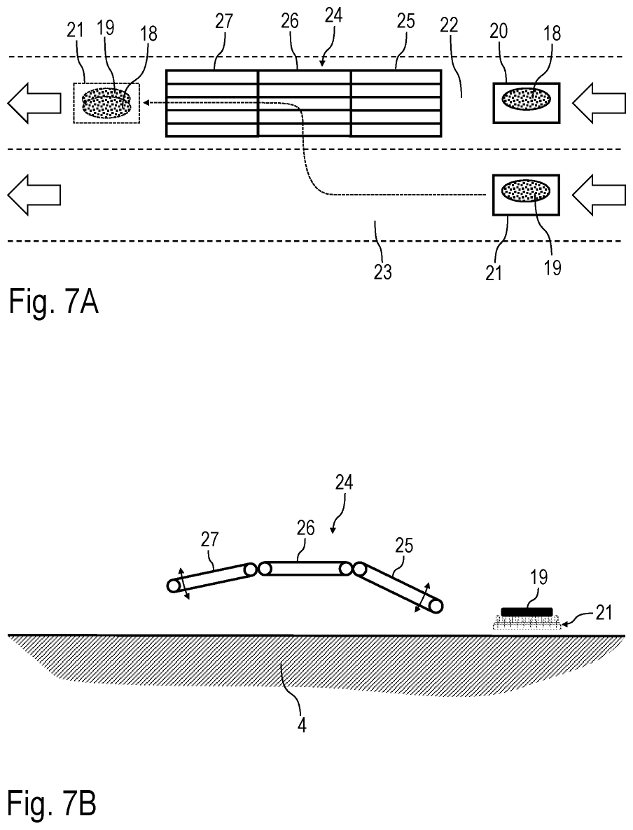

FIG. 7A shows a schematic top view of a food-processing system according to the invention which also allows overlapping of food product portions.

FIG. 7B shows a side view of the food-processing system according to FIG. 7A.

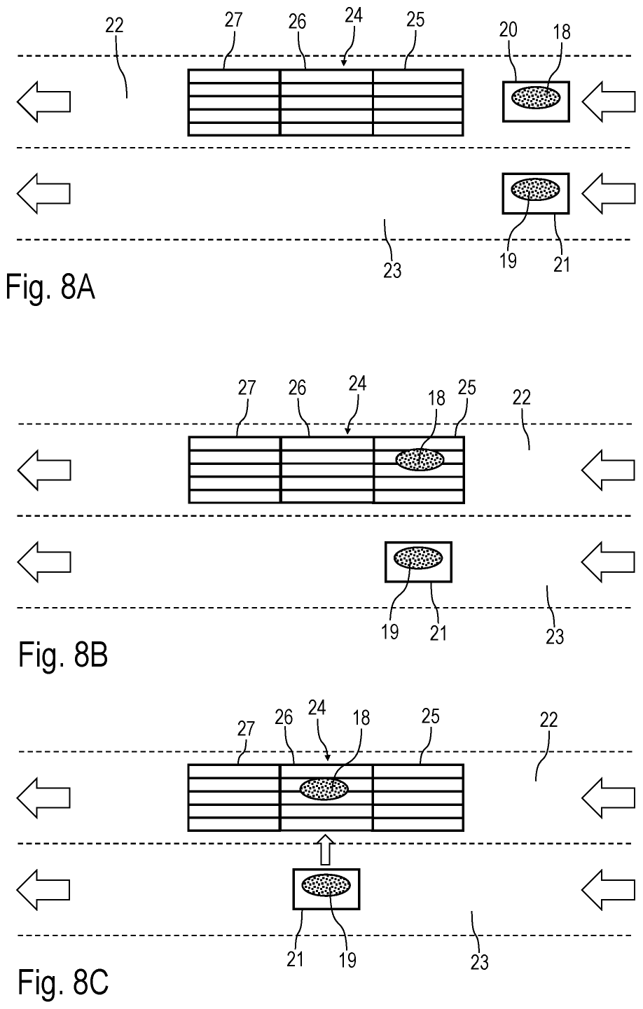

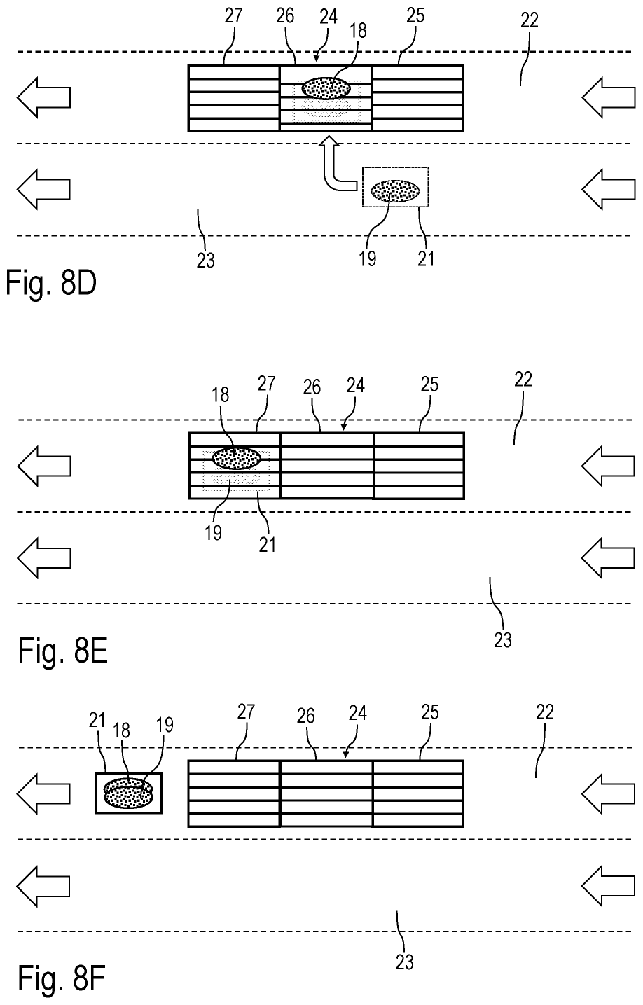

FIGS. 8A-8F show various steps of the operating method for overlapping food product portions according to the invention.

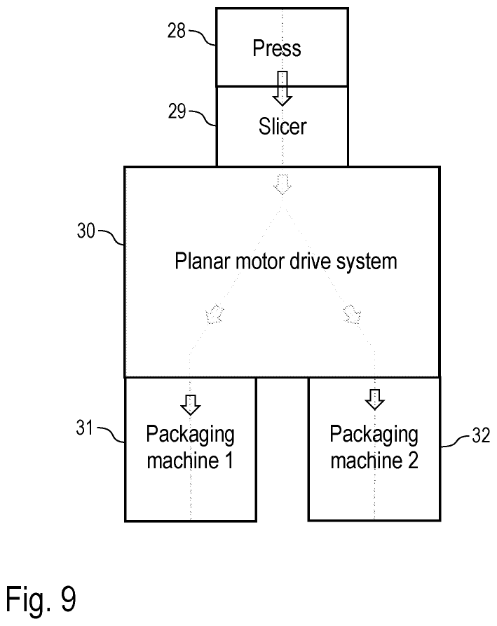

FIG. 9 shows a schematic representation of a food-processing system according to the invention, in which a cutting device feeds two packaging machines.

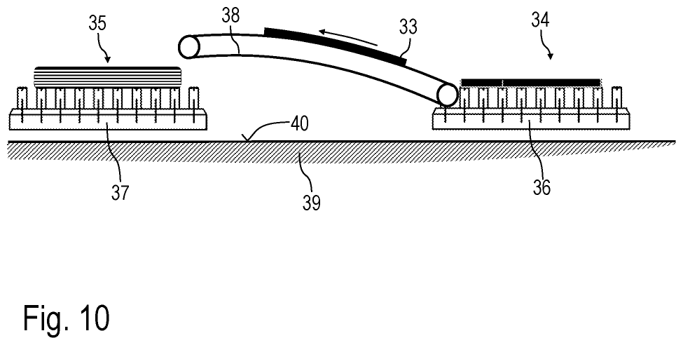

FIG. 10 shows a schematic diagram for the transfer of slices between different conveyors.

The following describes an example of a food-processing system according to the invention as shown in FIG. 1.

The food-processing system first of all has a cutting device 1, which is also referred to as a “slicer” in accordance with the usual technical terminology, and which slices food products (e.g. pieces of cheese, pieces of meat, salami sticks, etc.). In the illustrated embodiment, the cutting device operates in three tracks, i.e., the food products are sliced in three tracks side by side.

In addition, the food-processing system has a delivery conveyor 2 that picks up the slices cut by the cutting device 1 and deposits them on conveyed-products carriers 3 (“movers”) of a planar motor drive system 4. The planar motor drive system 4 is the planar motor drive system “XPlanar”, which is distributed by the German company Beckhoff Automation GmbH. It should be mentioned that the conveyed-products carriers 3 can be moved freely within a horizontal conveying surface without being bound to a fixed conveying path. The conveying surface is composed of numerous rectangular modules 5, whereby this modular structure of the planar door drive system 4 allows great flexibility with regard to the shape of the conveying surface.

The delivery conveyor 2 deposits a food product portion 6 on each of the conveyed-products carriers 3, whereby the food product portions 6 in the illustrated embodiment are shingles consisting of several slices which lie staggered one above the other.

The conveying surface of the planar motor drive system 4 is spanned by a checking station 7, which contains several cameras for checking the food product portions 6 on the conveyors 3. For example, the cameras in the checking station 7 can detect the number of slices in the individual food product portions 6 and thereby detect faulty portions with an insufficient number of slices. In addition, the cameras in the checking station 7 can, for example, also detect other defects (e.g., fat eyes) in the food product portions 6.

The checking station 7 can also measure the weight of the conveyed-products carriers 3 with the food product portions 6 on them. Thus, during operation, the conveyed-products carriers 3 with the food product portions 6 thereon float above the conveying surface of the planar door drive system 4 at a certain distance, which depends on the weight of the conveyed-products carrier 3 with the food product portions 6 thereon. The width of the air gap between the conveyed-products carrier 3 and the conveying surface of the planar motor drive system 4 thus forms a measure of the weight of the food product portions 6 on the conveyed-products carrier 3. In the test station 7, therefore, the width of the air gap between the conveyed-products carrier 3 and the conveying surface of the planar motor drive system 4 can also be measured as a measure of the weight of the loaded conveyed-products carrier 3. Alternatively, it is possible that the width of the air gap between the conveyed-products carrier 3 and the conveying surface of the planar motor drive system 4 is kept constant by adjusting the power of the planar motor drive system 4 accordingly, with the power of the planar motor drive system 4 then forming a measure of the weight of the loaded conveyed-products carrier.

Alternatively, however, it is also possible for the weight of the conveyed-products carriers 3 to be measured in a separate weighing station located between the conveyor system and the slicer.

The checking station 7 thus determines the weight of the food product portions 6 on the conveyors 3 and also inspects the food product portions 6 optically with the cameras. The checking station 7 then sends a corresponding signal to a higher-level control device 8, which also controls the cutting device 1 and the delivery conveyor 2. If the checking station 7 determines that the food product portion 6 is an incorrect portion, the control device 8 controls the planar motor drive system 4 so that the conveyed-products carrier 3 with the food product portion 6 is discharged to a correction station 9. At the correction station 9, the faulty portion can then be corrected by, for example, adding a missing slice, to give just one example. Subsequently, the planar motor drive system 4 can feed the corrected miss portion back into the main conveying path.

If, on the other hand, the inspection in the checking station 7 shows that there is a non-usable initial piece or end piece on one of the conveyed-products carriers 3, the associated conveyed-products carrier 3 is transported by the planar motor drive system 4 to a discharge station 10, where the non-usable initial pieces or end pieces are then removed from the conveyed-products carrier 3 and disposed of.

The conveyed-products carriers 3 with the food product portions 6 thereon are then transported by the planar motor drive system 4 to a take-off conveyor 11, which removes the food product portions 6 from the respective conveyed-products carrier 3 and transports them in two parallel tracks to a packaging machine 12.

The packaging machine 1 operates here at two tracks, while the cutting device 1 operates at three tracks. The planar motor drive system 4 thus also enables track conversion from three input tracks to two output tracks.

Furthermore, it should be mentioned that the control device 8 not only controls the cutting device 1, the planar motor drive system 4 and the delivery conveyor 2. Rather, the control device 8 is also connected to the checking station 7, the correction station 9, the discharge station 10, the take-off conveyor 11 and the packaging machine 12. It should be mentioned here that the control device 8 is shown as a single component for simplicity. In fact, however, the control device 8 can also be realized as a distributed system with several controllers, whereby the controller can also be realized partly in hardware and partly in software.

Finally, it should be mentioned that the planar motor drive system 4 may also have a return track to transport empty conveyed-products carriers 3 back to the delivery conveyor 2. However, the return track is not shown in the drawing for simplicity.

FIGS. 2 and 3 show different views of one of the conveyed-products carriers 3 on the planar motor drive system 4. The design and operation of the conveyed-products carrier 3 is also described in the German patent application DE 10 2020 105 678.8, the contents of which are fully attributable to the present description. At this point, it is only necessary to mention that the conveyed-products carrier 3 has numerous pins 13 on its upper side, which protrude parallel to the top and are arranged in matrix form in rows and columns. The adjacent rows and also the adjacent columns include here at respective elongated recesses 14, 15 which facilitate the conveying away of the food product portions 6 from the conveyed-products carrier 3, as will be described in detail. Thus, FIG. 4 shows a side view of one of the take-off conveyors 11, which are pivotable about a pivot axis 16. In this case, the individual take-off conveyors 11 consist of a number of adjacent and relatively narrow finger conveyors which can dive into the elongated recesses 14 or 15 on the upper side of the conveyed-product carrier 3 in order to grip underneath and convey away the food product portions 6 on the conveyed-product carrier 3.

FIG. 5, on the other hand, shows a schematic representation of the delivery conveyor 2, which deposits the food product portions 6 on the individual conveyed-products carriers 3.

FIG. 6 shows a schematic illustration of the orientation function of the planar motor drive system 4. Thus, the planar motor drive system 4 can rotate the conveyed-products carriers 3 about their vertical axis so that the food product portions 6 on the conveyed-products carrier 3 have a predetermined orientation. FIG. 6 shows the conveyed-products carrier 3 during the product deposition of the food product portions 6 from the cutting device 1. Thus, the food product portions 6 are initially deposited on the conveyed-products carrier 3 with a misalignment angle α relative to the main conveyor device, which is detected by a camera 17. The conveyed-products carrier 3 is therefore rotated accordingly before the food product portion 6 is deposited on the conveyed-products carrier 3. After the product deposition of the food product portion 6 on the conveyed-products carrier 3, the conveyed-products carrier 3 is then rotated again accordingly, as shown in dashed lines in the drawing, whereby the food product portion 6 is then correctly aligned again despite the initial misalignment during the product deposition.

FIGS. 7A and 7B show different views of an alternative embodiment of a food-processing system according to the invention, which also allows overlapping of food product portions 18, 19. Here, the food product portions 18, 19 are conveyed on conveyed-products carriers 20, 21 in two parallel conveyor tracks 22, 23.

A belt conveyor 24 is arranged in the right-hand conveyor track 22, which consists of a take-off conveyor 25, an intermediate conveyor 26 and a discharge conveyor 27. The take-off conveyor 25 takes over the food product portions 18 from the conveyed-products carrier 20 and then passes the taken-over food product portion 18 on to the intermediate conveyor 26 and to the delivery conveyor 27. The delivery conveyor 27 then deposits the food product portions 18 on top of the food product portion 19 on the other conveyed-products carrier 21.

FIGS. 8A-8F now show the overlapping process in several successive stages.

In the stage according to FIG. 8A, the two conveyed-products carriers 20, 21 with the two food product portions 18, 19 are conveyed in the two conveyor tracks 22, 23.

At the stage shown in FIG. 8B, the food product portion 18 is removed from the conveyed-products carrier 22 and taken over by the take-off conveyor 25. At this stage, the conveyed-products carrier 21 with the food product portion 19 continues to move alongside the belt conveyor 24.

At the stage shown in FIG. 8C, the food product portion 18 has then reached the intermediate conveyor 26 and the other conveyed-products carrier 21 is located laterally next to it.

At the stage shown in FIG. 8D, the conveyed-products carrier 21 with the food product portion 19 is then below the intermediate conveyor 26.

At the stage shown in FIG. 8E, the two food product portions 18, 19 are then located one above the other on the delivery conveyor 27, on the one hand, and below it on the conveyed-products carrier 21, on the other hand.

In FIG. 8F, it is then shown that the delivery conveyor 27 has deposited the food product portion 18 on top of the food product portion 19 on the conveyed-products carriers 21, with the two food product portions 18, 19 overlapping.

Thus, the arrangement shown allows the food product portions 18, 19 to be arranged in an overlapping manner.

FIG. 9 shows a schematic representation of a food-processing system according to the invention with a press 28 which first presses the food products, which can be useful, for example, with frozen products and is known from the state of the art.

The press 28 then delivers the pressed food products to a cutting device 29 (“slicer”), which here operates in a single track.

The slicer 29 then transfers the food product portions from several slices to a planar motor drive system 30, as already described above, whereby the planar motor drive system 30 in each case moves conveyed-products carriers with the individual food product portions.

On the output side, the planar motor drive system 30 then feeds two packaging machines 31, 32. The planar motor drive system 30 thus enables two packaging machines 31, 32 to be fed by only a single cutting device 29.

Finally, FIG. 10 shows a schematic diagram for transferring individual slices 33 between two food product portions 34, 35 lying on two conveyors 36, 37. In the embodiment shown, the food product portion 35 on the conveyed-products carrier 37 is not complete, so the disc 33 is removed from the food product portion 34 and placed on the food product portion 35 for completion. For the transfer of the disk 33 between the two conveyed-products carriers 36, 37, a conveyor 38 is provided here, which has several narrow finger conveyors on the input side, which can dive into the elongated recesses between the adjacent pins in order to grip under the food product portion 34, as has already been described above. The drawing here is only schematic in order to illustrate the principle of transfer of the discs 33 between the conveyed-products carriers 36, 37. Furthermore, it should be mentioned that the conveyed-products carriers 35, 36 can be freely moved here on a planar motor drive system 39 within a horizontal conveying surface 40.

The invention is not limited to the preferred embodiments described above. Rather, the invention encompasses a multitude of variants and variations which also make use of the inventive concept and therefore fall within the scope of protection. In particular, the invention also claims protection for the subject matter and the features of the dependent claims independently of the claims referenced in each case and in particular also without the features of the main claim. The invention thus comprises various aspects of the invention which enjoy protection independently of each other.

### LIST OF REFERENCE SIGNS

1 Cutting device (“slicer”)
2 Delivery conveyor
3 Conveyed-products carriers
4 Planar motor drive system for driving the conveyed-products carriers
5 Modules of the planar motor drive system
6 Food product portion on the conveyed-products carrier
7 Checking station with cameras for checking the food product portions
8 Control device
9 Correction station
10 Discharge station
11 Take-off conveyor
12 Packaging machine
13 Pins on the upper side of the conveyed-products carrier
14, 15 Elongated recesses between the pins
16 Swivel axis of the take-off conveyor
17 Camera
18, 19 Food product portions
20, 21 Conveyed-products carriers
22, 23 Conveyor tracks
24 Belt conveyor
25 Take-off conveyor
26 Intermediate conveyor
27 Discharge conveyor
28 Press
29 Cutting device (“slicer”)
30 Planar motor drive system for driving the conveyors
31, 32 Packaging machines
33 Slice
34, 35 Food product portions
36, 37 Conveyed-products carriers
38 Transfer conveyor
39 Planar motor drive system
40 Conveying surface of the planar motor drive system

1. A food-processing system for processing food products, in particular for slicing pieces of meat, pieces of cheese, sausage sticks or salami sticks into slices, comprising:
a cutting device for cutting the food products into slices to form food product portions each consisting of one or more slices, and
a conveyor system for conveying the food product portions away from the cutting device along a main conveying path, wherein the conveyor system performs several of the following functions in the food-processing system:
buffering the food product portions delivered from the cutting device in a buffer zone on the conveyor system prior to further transport of the food product portions along the main conveyor path,
aligning of the food product portions in lateral direction transversely to the main conveying path by a displacement of the food product portions in lateral direction transversely to the main conveying path,
orientation of the food product portions relative to the main conveying path by a rotation of the food product portions relative to the main conveying path, and
product formatting from an incoming product format with a predetermined number of parallel conveyor tracks into an outgoing product format with a predetermined number of parallel conveyor tracks, wherein the number of incoming conveyor tracks is different from the number of outgoing conveyor tracks,
at wherein the conveyor system fulfills said plurality of functions by means of a discontinuous conveyor, said discontinuous conveyor comprising at least one conveyed-products carrier movable along said main conveying path, said main conveying path being freely programmable within a conveying surface.

2. The food-processing system according to claim 1, further comprising
a checking station for checking the food product portions conveyed by the conveyor system for compliance with predetermined product specifications and for detecting faulty portions among the food product portions that do not meet the predetermined product specifications, the checking station optionally being arranged between the cutting device and the conveyor system, and
an ejection station for ejecting the faulty portions from the main conveying path.

3. The food-processing system according to claim 2,
wherein the checking station weighs the food product portions and compares the weight of the food product portions with a predetermined target weight to determine the faulty portions, and/or
wherein the checking station optically checks the food product portions by means of a sensor, in particular by means of a camera, in order to detect defects, and classifies the checked food product portions as faulty portions as a function of the defects determined, the defects optionally being deviations in weight, deviations in volume, deviations in shape or deviations in quality.

4. The food-processing system according to claim 2,
wherein the ejection station discharges the faulty portions into a correction zone in which the faulty portions can be corrected manually or automatically, and
that wherein the ejection station reintroduces the corrected faulty portions from the correction zone into the main conveying path after they have been corrected in the correction zone.

5. The food-processing system according to claim 1,
wherein the cutting device produces, during a cutting operation of one of the food products, in each case an initial piece and an end piece, the initial piece and/or the end piece being non-recyclable and optionally consisting in each case of one or more slices, and
wherein the conveying system also takes over the initial piece and/or the end piece on one of the conveyed-products carriers from the cutting device, and
wherein the conveyor system comprises a discharge station for removing the non-usable initial piece and/or the non-usable end piece from the conveyed-products carrier and disposing of it.

6. The food-processing system according to claim 5, wherein the discharge station for removing the non-usable initial piece and/or the non-usable end piece from the conveyed-products carrier comprises:
a gripper for gripping the initial piece and/or the end piece on the conveyed-products carrier, the gripper preferably being guided by a robot, or
a suction device for sucking the initial piece and/or the end piece onto the conveyor support, the suction device preferably being guided by a robot, or
a movably guided pusher for pushing the initial piece and/or the end piece down from the conveyed-products carrier, or
a tilting device for tilting the conveyed-products carrier with the initial piece and/or end piece located thereon and for tilting the initial piece and/or end piece down from the conveyed-products carrier, or
a blowing device for blowing down the initial piece and/or the end piece from the conveyed-products carrier, or
a device for jerkily accelerating and/or braking the conveyed-products carrier, so that the non-usable end pieces slide off the conveyed-products carrier, or
a finger conveyor belt.

7. The food-processing system according to claim 1,
wherein the conveyor system comprises a rotating device for rotating the at least one conveyed-products carrier about an axis of rotation at right angles to the conveying surface in order to set a predetermined orientation of the food product portion on the conveyed-products carrier,
wherein the rotating device is optionally formed by the discontinuous conveyor,
wherein the conveyor system optionally comprises a sensor, in particular a camera, for detecting the orientation of the food product portions on the conveyed-products carriers.
wherein the conveyor system optionally comprises a control device which is connected on the input side to the camera and on the output side to the rotating device and controls the rotating device as a function of the determined orientation of the food product portion,
wherein the camera is optionally arranged further downstream in the main conveying path than the rotating device, and
wherein the rotating device is optionally arranged directly on the cutting device, so that the slices off by the cutting device are deposited on the conveyed food product portion carrier, which is rotated by the rotating device into a desired orientation.

8. The food-processing system according to claim 1,
wherein a belt conveyor with a specific conveying direction is arranged above the conveying surface of the discontinuous conveyor,
wherein the discontinuous conveyor delivers a first conveyed-products carrier with a first food product portion which is taken over by the belt conveyor (24),
wherein the discontinuous conveyor delivers a second conveyed-products carrier with a second food product portion and positions the second conveyed-products carrier on the conveying surface under the belt conveyor,
wherein the discontinuous conveyor moves the second conveyed-products carrier out from under the belt conveyor in the conveying direction of the belt conveyor (24), whereby the belt conveyor deposits the first food product with an at least partial overlap on the second food product lying on the second conveyed-products carrier, and
wherein optionally a control device controls the discontinuous conveyor and the belt conveyor for carrying out steps b) to d).

9. The food-processing system according to claim 1,
wherein the conveyor system comprises a transfer device for transferring slices of the food product portions between different conveyed-products carriers for assembling complete food product portions from several incomplete food product portions,
that wherein the transfer device is optionally a belt conveyor.

10. The food-processing system according to claim 1,
wherein the food-processing system comprises a certain number of cutting devices, each supplying at least one conveying stream of the food product portions, the number of cutting devices being greater than or equal to one, and
wherein the food-processing system comprises a certain number of packaging machines, each receiving a delivery stream of the food product portions and packaging the food product portions delivered in the delivery stream into packages, the number of packaging machines being greater than or equal to one.

11. The food-processing system according to claim 10,
wherein the number of the cutting devices is different from the number of the packaging machines, and
wherein the conveyor system
divides the conveying streams arriving on the input side from the at least one cutting device into a plurality of conveying streams on the output side for feeding the individual packaging machines, or
combines the multiple conveying streams incoming on the input side from the multiple cutting devices into at least one conveying stream for feeding the at least one packaging machines.

12. The food-processing system according to claim 9, wherein the conveyor system transfers loaded conveyed-products carriers between the different conveyor streams.

13. The food-processing system according to claim 1,
wherein the food-processing system comprises a control device which controls the operation of the food-processing system,
wherein the control device is connected to at least one of the following components of the food-processing system for controlling the operation of the food-processing system:
the discontinuous conveyor,
the cutting device,
the checking station,
the ejection station,
the discharge station,
the camera,
the transfer device,
the packaging machine,
the delivery conveyor, and
the take-off conveyor, and
wherein the control device optionally includes a control computer and a program memory in which a control program is stored, the control program, when executed, causing the control computer to control the food-processing system.

14. (canceled)
